(19) United States
(12) Patent Application Publication
(10) Pub. No.: US 2018/0103004 A1
(43) Pub. Date: Apr. 12, 2018

(54) REENGAGING WEBSITE VISITORS WITH SOCIAL NETWORKING SYSTEM ELECTRONIC MESSAGES

(71) Applicant: Facebook, Inc., Menlo Park, CA (US)

(72) Inventors: Deniz Demir, Santa Clara, CA (US); Wenyun Yang, Fremont, CA (US); Robert Franklin Daniel, Redwood City, CA (US); Yoram Talmor, Cupertino, CA (US); Edward Young Zhang, San Francisco, CA (US); Aayush Gupta, San Mateo, CA (US); Ramkumar Natarajan, Redmond, WA (US)

(21) Appl. No.: 15/288,723

(22) Filed: Oct. 7, 2016

(51) Int. Cl. H04L 12/58; H04L 29/08

(52) U.S. Cl. CPC H04L 51/32; H04L 67/02; H04L 51/02; H04L 51/16

(57) ABSTRACT

The present disclosure is directed toward systems and methods for reengaging website visitors via a social networking system. For example, in accordance with one embodiment, a social networking system receives information regarding a user-triggered event associated with a merchant webpage, utilizes the received information to generate an electronic message from the merchant to the user, and provides the electronic message to the user via the social networking system. The user can then reengage with the merchant in response to the received electronic message.

### CROSS REFERENCE TO RELATED APPLICATIONS

N/A

### BACKGROUND

Website managers are constantly looking for additional ways to optimize a website visitor's online experience in order to increase the visitor's engagement with the website. For example, a website manager may tailor an advertisement to the interests of a particular website visitor. Similarly, the website manager can personalize portions of content within a web page to a particular website visitor in order to make the web page more appealing for that visitor. Ultimately, the website manager generally makes it a goal to keep website visitors coming back to the website to make more purchases, read more articles, post more comments, and so forth.

To illustrate, a website manager who manages an e-commerce website may notice many customers who place items in their online shopping cart, only to leave the website before purchasing anything. Typically, the website manager desires to have a way to reengage those website visitors who have abandoned their shopping carts prior to purchasing. In some cases, upon determining that a website visitor is leaving the website and abandoning his shopping cart, website managers have attempted to reengage the website visitor with a popup window that asks the visitor if he is sure he wants to leave. Website visitors generally find this tactic to be pushy and ineffective.

In another example, a website manager who manages a news website may notice that many visitors are only reading a single article before leaving the website. Accordingly, the website manager may attempt to reengage the website visitors by providing targeted links to related articles at the bottom and along the margins of the web pages in the website. This approach to reengagement, however, leads to cluttered web page layouts that are either overwhelming and confusing for web site visitors, or are simply ignored by web site visitors.

Accordingly, there are many disadvantages to typical methods for reengaging web site visitors. Thus, a need exists for an unobtrusive and effective way for web site managers to reengage with website visitors.

### SUMMARY

One or more embodiments described herein provide benefits and/or solve one or more of the foregoing or other problems in the art with systems and methods for effectively reengaging website visitors. For example, systems and methods described herein utilize a tracking pixel embedded in a web page to provide information to a social networking system or other electronic messaging system in response to a user-triggered event. In one or more embodiments, systems and methods described herein then utilize the provided information to generate and provide an electronic message to the web page visitor via the social networking system. In at least one embodiment, the generated electronic message includes information indicating it is from the merchant or owner of the web page wherein the tracking pixel is embedded. Thus, systems and methods described herein reengage the web page visitor with the merchant or owner of the web page by sending an electronic message to the visitor from a forum outside the website, as will be discussed in greater detail below.

Additional features and advantages of the present application will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments will be described and explained with additional specificity and detail through the use of the accompanying drawings in which:

FIG. 1 illustrates a block diagram of an environment for implementing a reengagement system in accordance with one or more embodiments;

FIG. 2 illustrates a sequence-flow diagram illustrating interactions in a reengagement process between a client-computing device, a merchant server, and a social networking system in accordance with one or more embodiments;

FIGS. 3A-3C illustrate a series of graphical user interfaces in accordance with one or more embodiments;

FIG. 4 illustrates a detailed schematic diagram of a reengagement system in accordance with one or more embodiments;

FIG. 5 illustrates a flowchart of a series of acts in a method of reengaging a web page visitor with a merchant in accordance with one or more embodiments;

FIG. 6 illustrates a block diagram of an exemplary computing device in accordance with one or more embodiments;

FIG. 7 is an example network environment of a social networking system in accordance with one or more embodiments; and

FIG. 8 illustrates a social graph in accordance with one or more embodiments.

### DETAILED DESCRIPTION

One or more embodiments described herein provide benefits and/or solve one or more of the foregoing or other problems in the art with systems and methods for reengaging web page visitors by utilizing electronic messages sent by way of a networking or communication system (e.g., a social networking system or electronic messaging system). For example, a reengagement system leverages information sent by a tracking pixel embedded on a third-party web page. In one or more embodiments, the programming code behind the tracking pixel sends information to a networking or communication system (e.g., a social networking or electronic messaging system) in response to a user-triggered event initiated by a user and associated with the web page. In one or more embodiments, the reengagement system analyzes the information sent by the tracking pixel to determine a merchant or company associated with the web page, an identity of the user, and information related to the user-triggered event. In at least one embodiment, the reengagement system uses this information to automatically generate and send an electronic message to the user from the merchant or company via the networking or communication system. Accordingly, the disclosed system can automatically initiate communications between the user and the third party, to facilitate reengagement of the user by the third party.

By way of illustration, in one embodiment, a web site manager requests a tracking pixel from a social networking system. In one or more embodiments, a “tracking pixel” is a portion of computer code that places an invisible 1×1 pixel image on a web page and sends information to the networking or communication system (e.g., social networking system) in response to a user-triggered event. For example, a user-triggered event can be any event associated with a web page, such as when a website user enters a web page, sets up a new account, makes a purchase, abandons a shopping cart, and so forth. In at least one embodiment, the reengagement system utilizes the functionality of an existing pixel within a web page for tracking purposes. For example, a web page may already contain a pixel previously utilized by the networking or communication system for advertising purposes. In that case, the reengagement system can leverage the information provided by the advertising pixel for user tracking purposes.

In response to a user-triggered event, the code behind the tracking pixel collects certain information at a client-computing device operated by the user who initiated the user-triggered event, and sends the information to the networking or communication system (e.g., social networking system). The collected information typically comes from one or more browser cookies, temporary internet files, etc. and can include a user ID, a merchant ID, a user email address, selected shopping cart items, purchased items, and so forth.

In one or more embodiments, in response to receiving information related to the user-triggered event, the reengagement system identifies the user who initiated the user-triggered event, and automatically generates an electronic message related to the user-triggered event. For example, the reengagement system can determine the identity of the user who initiated the user-triggered event by analyzing information provided by the tracking pixel code. This information can include the user's email address, the user's networking or communication system identifier (e.g., a unique identifier identifying the user within the social networking system), the user's name, the user's IP address, and so forth. With this information, the reengagement system can match the user to his or her networking or communication system account.

Next, in at least one embodiment, the reengagement system makes a determination as to whether an electronic message should be sent to the identified user. In one or more embodiments, the reengagement system only sends electronic messages to identified users who meet threshold levels of availability and interest with regard to the networking or communication system and the website where the tracking pixel was triggered. For example, the reengagement system may only send messages to users who have a networking or communication system account and who have visited the web page where the pixel is embedded at least twice. In another example, the reengagement system may only send messages to users who have an account with the website hosting the web page embedded with the tracking pixel.

Following the determination as to whether an electronic message should be sent to the identified user, the reengagement system generates an electronic message for the user that is related to the user-triggered event. In one or more embodiments, the reengagement system generates an electronic message based on a template that is specific to a given type of user-triggered event. For example, the reengagement system can store a template specific to a “new account” user-triggered event, specific to a “purchase” user-triggered event, specific to an “abandon shopping cart” user-triggered event, and so forth. Accordingly, the reengagement system can analyze the information provided by the tracking pixel to determine the type of the user-triggered event, and then to identify the corresponding message template associated with that user-triggered event type. Additionally, the reengagement system can store templates that are specific to a particular merchant. For example, the merchant can create a template that includes a logo, specific colors, specific language, and so forth. The reengagement system can then use the merchant-specific template in response to a user-triggered event as configured by the merchant. In other embodiments, the reengagements system can store and utilize system-wide templates for use across multiple merchants.

Once the reengagement system identifies a message template associated with the user-triggered event type, the reengagement system populates the message template based on the information provided by the tracking pixel. For example, in one or more embodiments, each message template includes a combination of predetermined message elements (e.g., text, images, hyperlinks, etc.) and message element fields wherein personalized information can be added. If the user-triggered event is the user creating a new account, the reengagement system can populate the message element fields in the “new account” message template with the user's name and a special new member offer based on the user's browsing history. In one or more embodiments, the reengagement system generates a rich message object based on the populated message template that includes one or more hyperlinks, pictures, and so forth.

The reengagement system then provides the generated electronic message to the identified user via the networking or communication system (e.g., the social networking system). In one or more embodiments, the reengagement system supports messaging between two or more users in a communication thread (e.g., by way of a social networking system or messaging system). For example, in at least one embodiment, the merchant can be assigned a unique identifier used by the system. To illustrate, a social networking system can assign the merchant a unique page identifier (e.g., associated with a profile/page for the merchant on the social networking system) and/or a unique messaging identifier associated with the page identifier (e.g., uniquely identifying the merchant for messaging purposes and properly tying a messaging profile to a social networking profile/page). Thus, the system can utilize the unique identifiers to manage and/or generate messages and properly associate them with the merchant. From the user's perspective, the generated message appears to come directly from the merchant associated with the embedded web page.

In one or more embodiments, by interacting with the generated electronic message, a user can reengage with a merchant or company. For example, if the generated electronic message may include a hyperlink to a special discount offer in response to the user abandoning a shopping cart on a merchant website. By clicking the hyperlink, the user reengages with the merchant, and the merchant at least makes a discounted sale without having to spend significant time or resources to reengage the user. Although the present description provides example embodiments implemented with respect to a social networking system, one will appreciate that the features, processes, systems, and/or methods disclosed herein can be implemented with respect to any networking or communication system (e.g., a social networking or an electronic messaging system), or with respect to a combination of networking or communications systems (e.g., a combination of a social networking system and a separate electronic messaging system).

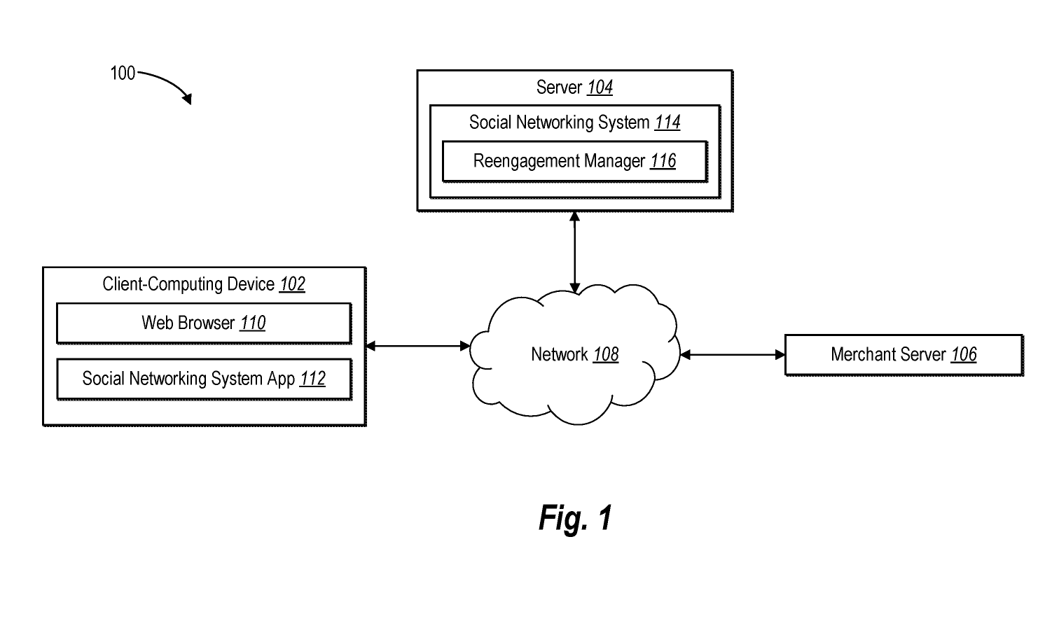

FIG. 1 illustrates an example block diagram of an environment for implementing the reengagement system 100. As illustrated in FIG. 1, the reengagement system 100 includes the client-computing device 102, the server 104 (which can include a combination of multiple server devices), and the merchant server 106, which are communicatively coupled through a network 108. As shown in FIG. 1, the client-computing device 102 includes a web browser 110 and a social networking system application 112. Further, the server 104 includes a social networking system 114 (or other electronic messaging system), which supports a reengagement manager 116.

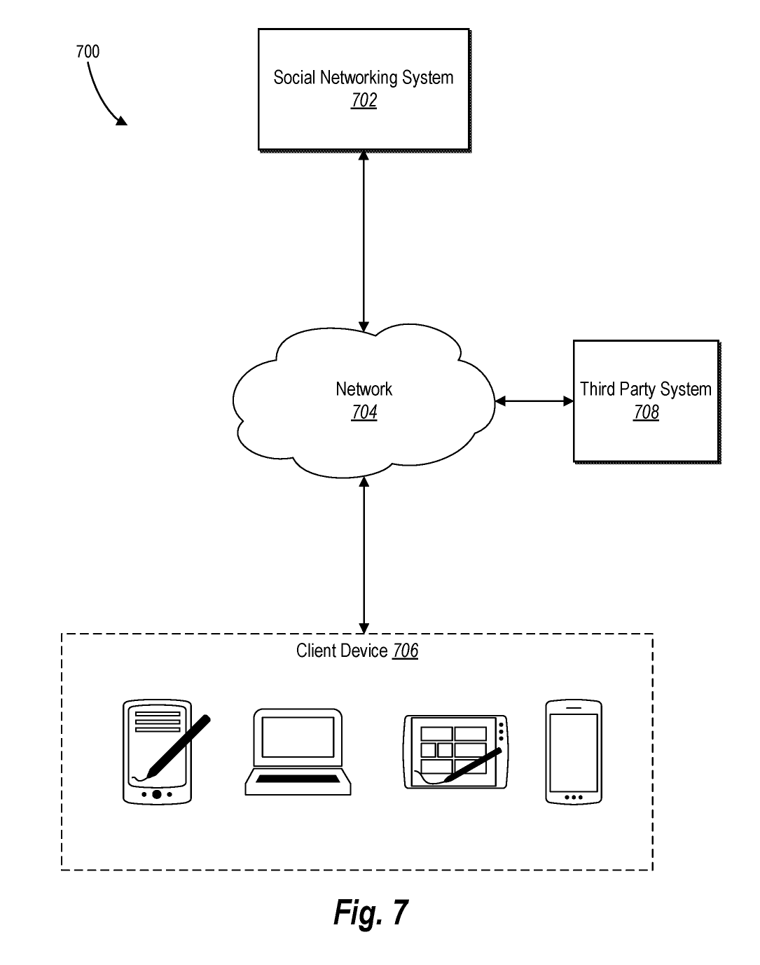

The client-computing device 102, the merchant server 106, and the social networking system 114 communicate via the network 108, which may include one or more networks and may use one or more communication platforms or technologies suitable for transmitting data and/or communication signals. In one or more embodiments, the network 108 includes the Internet or World Wide Web. The network 108, however, can include various other types of networks that use various communication technologies and protocols, such as a corporate intranet, a virtual private network (VPN), a local area network (LAN), a wireless local network (WLAN), a cellular network, a wide area network (WAN), a metropolitan area network (MAN), or a combination of two or more such networks. Although FIG. 1 illustrates a particular arrangement of the client-computing device 102, the server 104, the merchant server 106, and the network 108, various additional arrangements are possible. For example, the client-computing device 102 may directly communicate with the social networking system 114 and/or the merchant server 106, bypassing the network 108. Additional details relating to the network 108 are explained below with reference to FIG. 7.

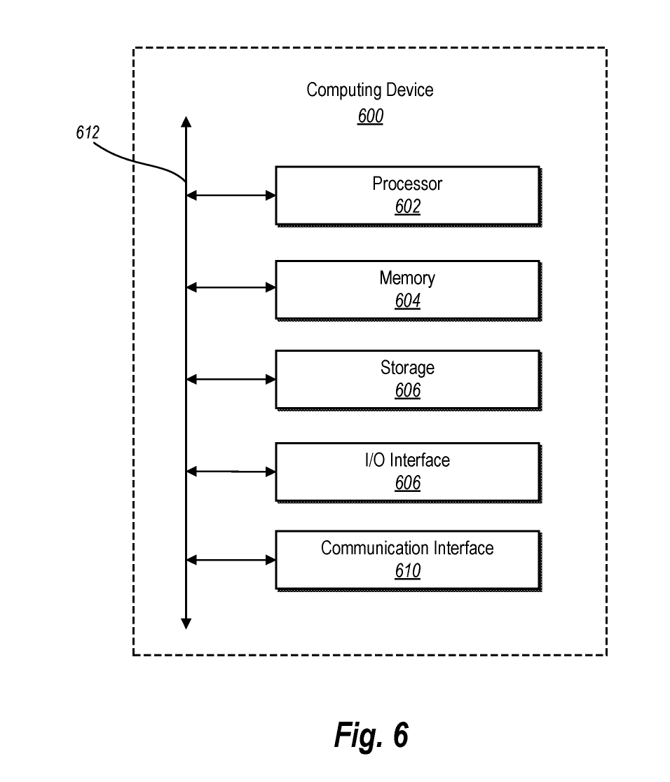

In one or more embodiments, the client-computing device 102 is one or more of various types of computing devices. For example, the client-computing device 102 includes a mobile device such as a mobile telephone, a smartphone, a PDA, a tablet, or a laptop. Additionally or alternatively, the client-computing device 102 may include a non-mobile device such as a desktop, a server, or another type of computing device. Additional details with respect to the client-computing device 102 are discussed below with respect to FIG. 6.

Further, as shown in FIG. 1, the client-computing device 102 runs a web browser 110 and a dedicated social networking system application 112. In one or more embodiments, the web browser 110 enables a user of the client-computing device 102 to request, view, and otherwise navigate websites and web pages. Additionally, in one or more embodiments, the social networking system application 112 is associated with the social networking system 114 and enables the user of the client-computing device 102 to access social networking system content (e.g., posts, newsfeeds, profiles, etc.).

In one or more embodiments, the social networking system application 112 also enables the user to view and compose electronic messages with one or more social networking system co-users. In at least one embodiment, the social networking system 114 organizes electronic messages exchanged between users into communication threads, wherein each thread includes a chronological ordering of electronic messages, as well as additional indicators as to who authored an electronic message and whether the electronic message has been delivered and/or read. In yet further embodiments, the social networking system application 112 is a dedicated messaging application.

In one or more embodiments, the merchant server 106 is a web server. For example, in at least one embodiment, the merchant server 106 hosts an e-commerce website including one or more web pages. In response to receiving a request for a particular webpage (e.g., by a user clicking a hyperlink) via the web browser 110 of the client-computing device 102, the merchant server 106 provides the corresponding hypertext markup language (“HTML”) file and any other support files to the client-computing device 102. Once the client-computing device 102 receives the data representative of the requested web page, the web browser 110 compiles or otherwise interprets the provided data and provides a display of the requested web page to the user of the client-computing device 102 via one or more displays associated with the client-computing device 102.

The functionality of the reengagement system 100 is described herein as operating in response to receiving information from a triggered tracking pixel embedded on a web page. In additional embodiments, the reengagement system 100 can also operate in response to receiving information from a native application that has been triggered by an event. For example, a user may download a native application associated with a merchant onto a mobile device. The user may then initiate one or more user-triggered events via the native application in same way as described above with reference to a user-triggered event on a web page. Thus, the computer code behind the tracking pixel described above and the computer code behind the native application can both collect information specific to the user-triggered event, and provide that information to the social networking system 114. In response to receiving the information specific to the user-triggered event, whether from a tracking pixel or from a native application, the social networking system 114 can generate and provide an electronic message to the user who initiated the user-triggered event.

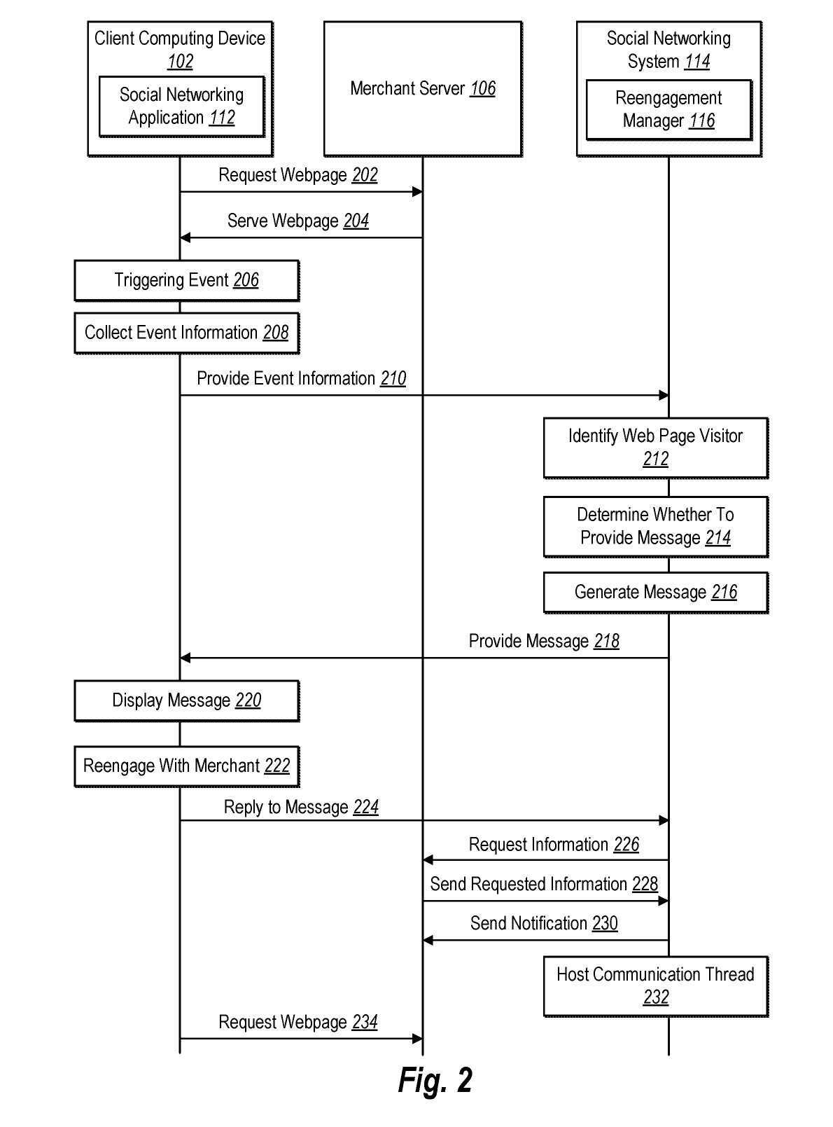

As discussed above, the systems and methods laid out with reference to FIG. 1 facilitate reengagement of users by providing information to the social networking system 114 in response to a user-triggered event on a web page or via a native application. FIG. 2 illustrates an example process diagram of one or more example embodiments of processes implemented by the reengagement system 100 discussed above. Consistent with the reengagement system 100 illustrated in FIG. 1, FIG. 2 illustrates the social networking system 114 facilitating reengagement of the user of the client-computing device 102 with the merchant server 106.

In one or more embodiments, and prior to the client-computing device 102 requesting a web page (202) from the merchant server 106, the merchant server 106 and the social networking system 114 have already collaborated on the creation and placement of a tracking pixel. For example, the manager of the merchant server 106, in response to determining a need to track user actions in relation to a particular web page hosted by the merchant server 106, can request tracking pixel computer code from the social networking system 114. In at least one embodiment, the manager of the merchant server 106 includes certain parameters in the request for the tracking pixel. Such parameters include, but are not limited to an event type that triggers the pixel (e.g., the user clicking submit on a new user account form, the user clicking a purchase button on a purchase confirmation web page, the user closing a web page that includes a shopping cart with items in it, etc.), the type of information that should be sent by the tracking pixel computer code once the tracking pixel is triggered (e.g., a user ID, a merchant ID, the user-triggered event type, other information related to the user-triggered event, etc.), and a location where such information is stored on the client-computing device 102 (e.g., the client-computing device 102 may maintain one or more browser cookies or other files where such information is stored).

In response to receiving the request for the tracking pixel from the merchant server 106, the social networking system 114 generates the computer code for the tracking pixel. For example, with the parameters provided by the manager of the merchant server 106, the social networking system 114 generates a snippet of code that places an invisible 1×1 pixel image on a web page and the sends information defined by the provided parameters to the social networking system 114. The social networking system 114 then returns the generated computer code snippet for the tracking pixel to the merchant server 106. In at least one embodiment, the manager of the merchant server 106 adds the provided code for the tracking pixel to the HTML code representing a web page. Accordingly, when a web browser displays the web page, the tracking pixel is initiated, and the computer code behind the tracking pixel will send information to the social networking system 114.

For example, as shown in FIG. 2, the user of the client-computing device 102 requests a web page (202) from the merchant server 106. In this example, the manager of the merchant server 106 has previously interacted with the social networking system 114 to receive tracking pixel computer code, and embed the received tracking pixel computer code in the data representative of the web page. In one or more embodiments, the request for the web page (202) is the result of the user of the client-computing device 102 clicking on a hyperlink or entering a uniform resource locator (“URL”) into the web browser 110 of the client-computing device 102. In response to receiving the request for the web page (202), the merchant server 106 serves or otherwise provides the HTML data representative of the requested web page (204) to the web browser 110 of the client-computing device 102. Once the web browser 110 receives the web page from the merchant server 106, the web browser 110 provides a display of the web page to the user of the client-computing device 102 such that the user may interact with the displayed web page via the web browser 110.

In at least one embodiment, the client-computing device 102 requests social networking system information related to the user of the client-computing device 102 as soon as the merchant server 106 serves the webpage (204). For example, in response the client-computing device 102 rendering the webpage served by the merchant server 106, the tracking pixel embedded on the now-rendered webpage can request information related to the user of the client-computing device 102 from the social networking system 114. For instance, the tracking pixel can provide identifying information for the user (e.g., the user's name, email address, etc.) that is stored on the client-computing device 102 (e.g., in a cookie or other file) to the social networking system 114. In response to receiving this information, the social networking system 114 can identify a social networking system user ID for the user of the client-computing device 102, and return the social networking system user ID to the client-computing device 102. The client-computing device 102 can later use the provided social networking system user ID when communicating with the social networking system 114 in response to a triggering event.

In at least one embodiment, the tracking pixel identifies the user's social networking system user ID provides the user ID to the social networking system 114. In some embodiments, the user of the client-computing device 102 generally has already logged into the social networking system 114 and has an active login and/or open social networking system web page within an active browser window on the client-computing device 102. In one or more embodiments, when the user of the client-computing device 102 logs into the social networking system 114 via a web interface, a web page associated with the social networking system 114 may store a browser cookie or other temporary file on the client-computing device 102 that includes the user's social networking system user ID. Thus, the tracking pixel can identify the user's social networking system user ID for use in further communications with the social networking system 114.

Alternatively, the user of the client-computing device 102 may have logged into the social networking system 114 via the social networking system application 112. In that case, the social networking system application 112 may store a temporary file on the client-computing device 102 that includes the user's social networking system user ID. Thus, the tracking pixel can identify the user's social networking system user ID from that temporary file. In one or more embodiments, the web page associated with the social networking system 114 or the social networking system application 112 may cause the browser cookie or other temporary file containing the user's social networking system user ID to be deleted from the client-computing device 102 when the user logs out of the social networking system 114.

In one or more embodiments, while interacting with the web page, the user of the client-computing device 102 initiates a user-triggered event (206). For example, a user-triggered event can be defined by the manager of the merchant server 106 as any user interaction with a web page. To illustrate, a user-triggered event can be when a user clicks a “Submit” button on a web page where the user enters new account information (e.g., user name, password, email address, etc.). Similarly, a user-triggered event can be when a user clicks a “Make Purchase” button on a final web page in a purchase sequence. Furthermore, a user-triggered event can be a user closing a web page associated with a shopping cart that includes one or more items selected by the user. In additional embodiments, the user-triggered event can include or be based on any other user interaction with the web page.

In accordance with and/or in response to the user of the client-computing device 102 triggering a user-triggered event (206), the computer code behind the embedded tracking pixel collects event information (208) from the client-computing device 102. In one or more embodiments, the client-computing device 102 stores a variety of information in browser cookies, temporary internet files, and other storage mechanisms. This information can include, but is not limited to, the user's email address and other identifying information, one or more social networking system user IDs associated with the user, merchant account information, browsing history, payment information, and so forth. Accordingly, in at least one embodiment, the tracking pixel computer code collects event information by retrieving information related to the user-triggered event from data stored on the client-computing device 102.

After collecting the event information (208), the code behind the embedded tracking pixel provides the collected event information (210) to the social networking system 114. In one or more embodiments, the tracking pixel code provides the event information (210) to the social networking system 114 by utilizing a network connection to send the event information as a data stream to a preconfigured communication endpoint at the social networking system 114 (e.g., a uniform resource locator). In additional or alternative embodiments, the tracking pixel code can provide event information (210) by utilizing file transfer protocol, or any other data transferring mechanism. In at least one embodiment, the tracking pixel code may provide event information (210) directly to the merchant server 106. In that case, the merchant server 106 can utilize the provided event information for its own purposes and/or forward the event information on to the social networking system 114.

Once the social networking system 114 receives information about the user-triggered event on the client-computing device 102, the social networking system 114 identifies the web page visitor (212) who initiated the user-triggered event. In one or more embodiments, the determined identity of the web page visitor is the visitor's unique social networking system ID that the social networking system 114 can use to access the visitor's social networking system profile and other information. The social networking system 114 also utilizes the visitor's unique social networking system ID to send one or more messages to the visitor via the social networking system application 112 (as shown in FIG. 1).

In one or more embodiments, the social networking system 114 determines the identity of the web page visitor (212) by analyzing the user-triggered event information provided by the tracking pixel code on the client-computing device 102. For example, if the information provided by the tracking pixel code includes a social networking system user ID, the social networking system 114 matches the social networking system user ID to a social networking system user account that includes the web page visitor's name, email address, geographic information, profile information, relationship information, and so forth. In another example, if the information provided by the tracking pixel code includes an email address, the social networking system 114 matches the email address to a social networking system user account. In yet another example, the information provided by the tracking pixel code may include an identifier for the web page visitor that is specific to the merchant. In that case, the social networking system 114 can identify the web page visitor by matching the merchant specific identifier to a list of users and identifiers previously provided to the social networking system 114 by the merchant server 106.

After the social networking system 114 identifies the web page visitor (e.g., the user of the client-computing device 102), the social networking system 114 next determines whether to provide an electronic message to the visitor (214) based on the user-triggered event. In one or more embodiments, the social networking system 114 makes the determination as to whether to provide an electronic message to the user of the client-computing device 102 based on calculating a score based on a variety of factors. If the score is above a predetermined threshold, the social networking system 114 generates the electronic message (216), and provides the electronic message (218) to the user of the client-computing device 102.

In one or more embodiments, the social networking system 114 calculates the score to determine whether to provide an electronic message based on factors that indicate how receptive the user of the client-computing device 102 will be to receiving a message from the merchant server 106 via the social networking system 114. For example, factors that indicate how receptive the user will be include, but are not limited to, whether the user has previously received messages from this or other merchants via the social networking system 114, an engagement level between the user and the merchant (e.g., as indicated by the user's browser history, the user's membership history with the merchant, etc.), a relationship coefficient between the user and the merchant (e.g., based on the user's social networking system activity), how often the social networking system 114 provides messages to the user from this or other merchants, the user's privacy settings related to receiving messages from the social networking system 114, and so forth. In at least one embodiment, for each factor that indicates the user will be receptive to receiving a message from the merchant server 106 via the social networking system 114, the social networking system 114 increases the user's score. If the ultimate score is above a predetermined threshold, the social networking system 114 determines that an electronic message from the merchant server 106 should be provided to the user of the client-computing device 102.

In response to determining that an electronic message should be provided to the user of the client-computing device 102, the social networking system 114 generates an electronic message (216). In one or more embodiments, the social networking system 114 generates the electronic message (216) by first identifying a template specific to the user-triggered event and/or associated with the merchant. For example, in at least one embodiment, the social networking system 114 stores a variety of message templates that are specific to different types of user-triggered events. To illustrate, each of the variety of message templates includes formatting, font choices, predetermined text, and other style specifications that are unique to a type of user-triggered event. Thus, if the user-triggered event occurs when a user makes a purchase on a merchant web page, the corresponding message template for a purchase user-triggered event may include predetermined text (e.g., “Thanks for your purchase! It should ship soon.”), formatting and text specifications that place the predetermined text at the top of the message with space for a listing of the purchased items below, and so forth. In at least one embodiment, the social networking system 114 determines which message template to use by identifying a type of user-triggered event from the event information provided by the client-computing device 102 (210).

After the social networking system 114 has identified a message template that corresponds to the user-triggered event, the social networking system 114 next generates the message (216) by personalizing the message template with a subset of the event information provided by the client-computing device 102. For example, if the user-triggered event is a purchase (e.g., indicated by the user of the client-computing device 102 clicking a “Purchase” button on a merchant web page), the social networking system 114 can personalize the “purchase” message template with information such as the items being purchased, the cost of the items purchased, the estimated shipping date, etc. In another example, if the user-triggered event is an abandoned cart (e.g., indicated by the user closing a web page/website that includes a shopping cart of items the user has selected but not purchased), the social networking system 114 can populate the “abandon cart” message template with information such as the items in the abandoned shopping cart, the cost of the items in the abandoned shopping cart, discount offers for one or more items in the abandoned shopping cart, and so forth. Alternatively or additionally, rather than allowing the social networking system 114 to generate the message (216), an administrator associated with the merchant can manually generate the message (216).

The social networking system 114 next provides the generated electronic message (218) to the client-computing device 102. In one or more embodiments, the social networking system 114 provides the generated electronic message to the client-computing device 102 via a social networking system application 112 installed on the client-computing device 102. For example, in at least one embodiment, the social networking system 114 supports communication threads wherein two or more social networking system users can exchange electronic messages.

Accordingly, in one or more embodiments, the social networking system 114 provides the electronic message (218) to the user of the client-computing device 102 by starting a new communication thread between the user and the merchant, adding the generated electronic message to the new communication thread, and providing the communication thread to the client-computing device 102 via the social networking system application 112. In additional or alternative embodiments, the social networking system 114 can provide the electronic message (218) to the user of the client-computing device 102 in other ways (e.g., via an email, a social networking system post, etc.).

In response to receiving the generated message from the social networking system 114, the client-computing device 102 displays the electronic message (220). As discussed above, in one or more embodiments, the client-computing device 102 displays the electronic message (220) via a social networking system application 112 installed on the client-computing device 102. For example, the social networking system application 112 displays the generated electronic message as part of a communication thread between the user of the client-computing device 102 and the merchant.

At this point, the user of the client-computing device 102 may reengage with the merchant (222) via the social networking system 114. For example, in response to receiving the electronic message from the merchant via the social networking system application 112, the user of the client-computing device 102 can easily reply to the generated electronic message (224) in the communication thread. To illustrate, in response to receiving a generated electronic message from the merchant, “Thanks for purchasing this red shirt!” the user of the client-computing device 102 can reply to the message directly via the social networking system 114 with another electronic message, “Can I also order a second shirt in blue?”

In some embodiments, the social networking system 114 can continue to communicate with the user by generating and sending one or more automated messages to the user. For example, in response the reply received by the social networking system 114 from the client-computing device 102, the social networking system 114 can automatically generate a response and send the automated response to the client-computing device 102. This process can continue until such time that the social networking system 114 determines that the communication with the user or a particular message from the user necessitates human intervention or is ready to pass on to a human administrator (e.g., once sufficient information has been automatically gathered). At this time, the social networking system 114 can notify the merchant that the communication thread requires attention. To illustrate, in some embodiments, the social networking system 114 can alert a page administrator associated with a profile page for the merchant on the social networking system 114. Accordingly, as part of the merchant's administration of its social networking page, it can be notified of communication threads that require attention and/or response from the merchant.

In one or more embodiments, the social networking system 114 utilizes artificial intelligence technologies to engage in a communication thread without any human interaction on behalf of the merchant. To illustrate, in some embodiments, the social networking system 114 implements and/or utilizes one or more messaging bots (or “messaging agents”) and corresponding bot logic to automatically communicate with the user. An example messaging bot can utilize various technologies and routines to emulate human activity within a conversation until the conversation is ready to be passed on to a human administrator. In particular, in at least one embodiment, the social networking system 114 utilizes natural language processing, neural network models, adaptive algorithms, grammars, and so forth to analyze event information, and understand a message from a user. By leveraging the abilities of this artificial intelligence, the social networking system 114 can generate and provide electronic messages to the user of the client-computing device 102 via the hosted communication thread on behalf of the merchant and in a way that emulates human activity. For example, the messaging bot can utilize natural language processing to determine a subject and intent of a message received from the client-computing device 102, and then automatically formulate a response based on the determined subject and intent of the user. For example, the messaging bot might analyze the message “Can you let me know when this will be delivered,” and determine that the message is requesting information regarding the timing of delivery and then automate a message that includes an expected delivery time and/or corresponding package tracking information. As another illustration, and continuing on the example from above, if the received message inquires “Can I also order a second shirt in blue?,” the messaging bot can analyze the language of the message as well as information regarding the user's order (or other event information) to determine that the user is requesting to add a new item of a different color to the order. In response, the messaging bot can determine which item the user wants to add to the order and provide a message regarding the availability of the item, the additional cost of adding the item, and a request to confirm instructions to add the item to the order. Based on a subsequent message from the user (e.g., confirming the instructions to add the item), the messaging bot can provide further responses to the user (e.g., informing the user that the item will be added to the order) and trigger one or more operations in to fulfill any requests from the user (e.g., send instructions to the merchant server 106 to add the new item to the user's order). Accordingly, by utilizing and/or implementing messaging bots, the social networking system 114 can emulate human activity within a communication thread with the user and automatically perform one or more tasks for further engaging and providing service to the user on behalf of the merchant.

In some embodiments, the social networking system 114 can provide options to a merchant for customizing a messaging bot to be used on its behalf. For example, the social networking system 114 can receive instructions from the merchant server 106 regarding the content, tone, style, logic, algorithms, and/or routines to be utilized by the messaging bot. The social networking system 114 can them uniquely train the messaging bot to perform in accordance with the received instructions. Accordingly, the merchant can customize the messaging bot in a way that is unique to and consistent with the procedures, capabilities, and personality of the merchant.

Additional details regarding messaging bots is provided in U.S. Provisional Patent Application No. 62/321,082, titled “Techniques for Messaging Agent Interactions,” filed on Apr. 11, 2016, which is hereby incorporated by reference in its entirety.

Additionally or alternatively, the social networking system 114 can communicate with the merchant server 106 in order to receive and/or maintain up-to-date information regarding the merchants products and services. For example, as shown in FIG. 2, the social networking system 114 can request information from the merchant server 106 (226) and the merchant server 106 can send the requested information back to the social networking system 114 (228). To illustrate, and again using the example from above, in response to a received message that asks “Can I also order a second shirt in blue?,” the social networking system 114 can send a request to the merchant server 106 requesting information regarding the availability of the requested item and possibility of adding the item to the user's order. The merchant server 106 can then respond with, for example, an indication of the item's availability as well as pricing information or an updated receipt/invoice for the user's order. The social networking system 114 can then utilize the received information to respond to the user's message.

In some embodiments, the merchant server 106 automatically and/or periodically provides information to the social networking system 114 without the need for a request for information from the social networking system 114. For example, the merchant server 106 can periodically provide information updates to the social networking system 114 regarding, for example, inventories, pricing, product availability, sales or special promotions, shipping costs, etc., which the social networking system 114 can utilize when communicating with the merchant's customers. In this manner, the social networking system 114 has up-to-date information and can avoid unnecessary requests for information to the merchant server 106 as well as corresponding delays in responding to user messages.

As mentioned above, in some embodiments the social networking system 114 can send a notification to the merchant server 106 or to a page administrator associated with the merchant (230) to inform the merchant that a communication thread requires human attention. For example, based on communications with a user, the social networking system 114 can determine that it does not have the necessary information or instructions to continue the conversation with the user or that, based on merchant preferences, the conversation should be passed on to a human administrator for the merchant. In at least one embodiment, the social networking system 114 can provide an administrator page associated with the merchant's social networking page, through which page administrators can view insights, posts, messages, communication threads, notifications, etc. In some embodiments, the social networking system 114 can manage and maintain an inbox that is accessible by page administrators and that can include messages, threads, and/or alerts that require the merchant's attention. Accordingly, a human administrator can access the inbox to perform the tasks necessary to address and/or respond to items requiring human attention. In some embodiments, the social networking system 114 can intelligently distribute tasks, notifications, and messages requiring human response among multiple page administrators to facilitate efficient resolution by the page administrators as a whole. The distribution of such items can be based on, for example, the expertise, availability, experience, division, and/or location of each page administrator.

Even after a communication thread is passed to a page administrator, the social networking system 114 can continue to host the communication thread (232) for ongoing communication between the user and the merchant. In other embodiments, a separate electronic messaging system can host the thread and facilitate communications between the merchant and the user.

Alternately or additionally, in response to receiving the generated electronic message from the merchant via the social networking system 114, the user of the client-computing device 102 can reengage directly with the merchant server 106 by requesting a web page (234) from the merchant server 106. For example, in one or more embodiments, the generated electronic message includes a hyperlink to a web page hosted by the merchant server 106. To illustrate, in response to an “abandon cart” user-triggered event, the social networking system 114 can provide an electronic message to the user of the client-computing device 102 that includes a link to a web page featuring a discount code available on the merchant server 106. Thus, the user of the client-computing device 102 may reengage with the merchant server 106 by clicking the hyperlink in the generated electronic message, which then causes the web browser 110 of the client-computing device to request a web page (228) from the merchant server 106.

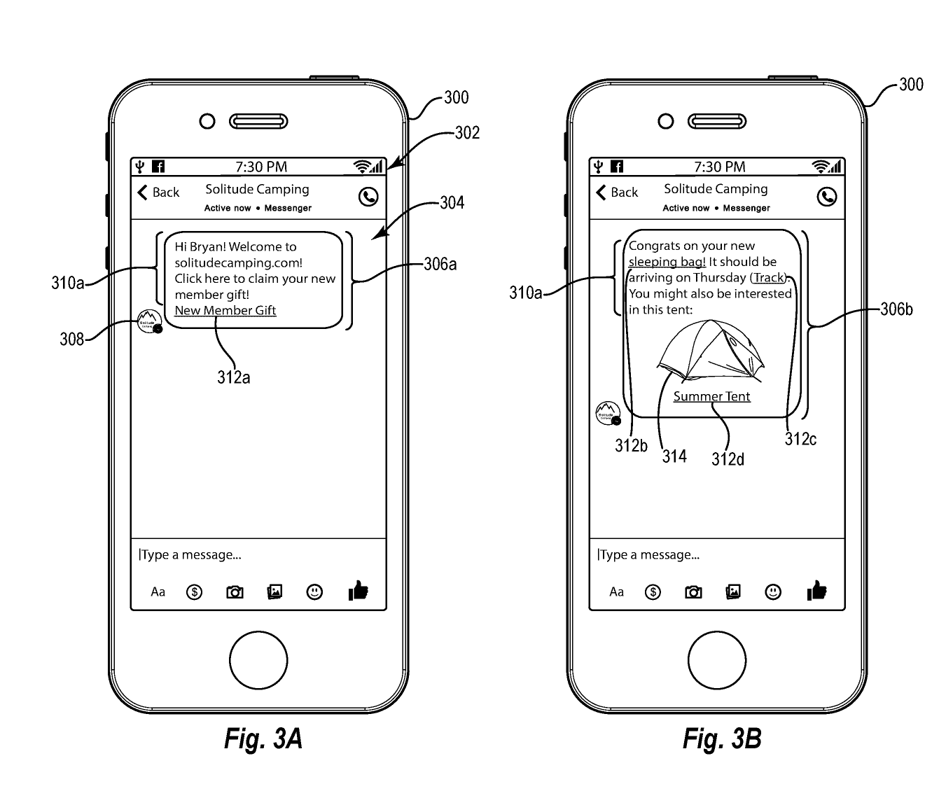

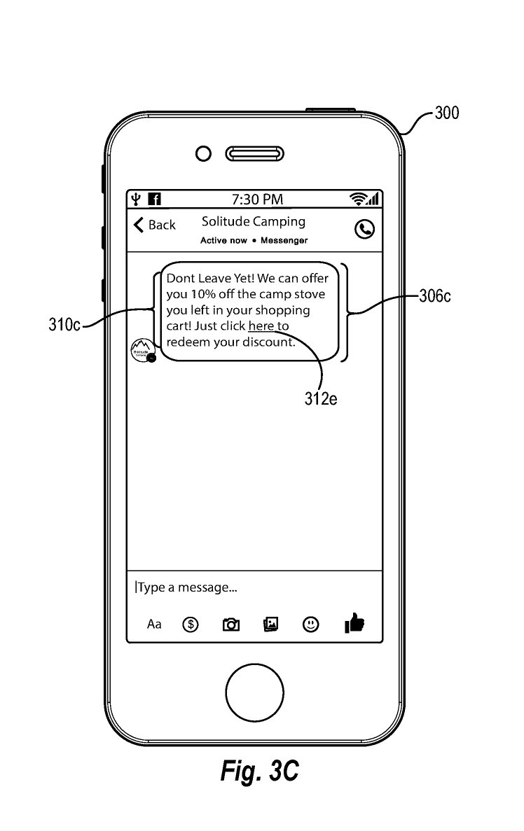

As will be described in more detail below, the components of the reengagement system 100 as described with regard to FIGS. 1-2 can provide, alone and/or in combination with the other components, one or more graphical user interfaces (“GUIs”). In particular, the social networking system application 112 can allow a user to interact with a collection of display elements for a variety of purposes. FIGS. 3A-3C and the description that follows illustrate various example embodiments of the user interfaces and features that are in accordance with general principles as described above.

For example, FIG. 3A illustrates a client-computing device 300 (e.g., which can represent an example of the client-computing device 102) that may implement one or more of the components or features of the reengagement system 100. As shown, the client-computing device 300 is a handheld device, such as a mobile phone device (e.g., a smartphone). As used herein, the term “handheld device” refers to a device sized and configured to be held/operated in a single hand of a user. In additional or alternative examples, however, any other suitable computing device, such as, but not limited to, a tablet device, larger wireless device, laptop or desktop computing, a personal digital assistant device, and/or any other suitable computing device can perform one or more of the processes and/or operations described herein.

As illustrated in FIG. 3A, the client-computing device 300 includes a touch screen display 302 that can display graphical user interfaces and by way of which user input may be received and/or detected. As used herein, a “touch screen display” refers to the display of a touch screen device. In one or more embodiments, a touch screen device may be the client-computing device 102 with at least one surface upon which a user may perform touch gestures (e.g., a laptop, a tablet computer, a personal digital assistant, a media player, a mobile phone, etc.). Additionally, or alternatively, the client-computing device 300 may include any other suitable input device, such as a touch pad or those described below with reference to FIG. 6.

In FIG. 3A, the touch screen display 302 of the client-computing device 300 displays a communication thread GUI 304 provided by the social networking system application 112 (or other electronic messaging application) installed thereon. As mentioned above, the social networking system application 112 enables the user of the client-computing device 300 to view and compose social networking system posts, and/or to send and receive electronic messages to and from one or more social networking system co-users in a communication thread. Also as described above, in response to the social networking system 114 determining to provide an electronic message to the client-computing device 102 via the social networking system application 112, the reengagement system 100 generates an electronic message. The reengagement system 100 generates the electronic communication based on the user-triggered event initiated by the user of the client-computing device.

For example, as shown in FIG. 3A, in response to a “new account” user-triggered event (e.g., the user of the client-computing device 300 entering new account information via the web browser 110), the reengagement manager 116 generates and provides the electronic message object 306a. In one or more embodiments, the electronic message object 306a is a rich object including an electronic message 310a, as well as one or more hyperlinks 312a and/or other content (e.g., images, videos, etc.). The reengagement manager 116 also provides a sender indicator 308 adjacent to the electronic message object 306a to indicate to the user of the client-computing device 300 that the electronic message 310a is from the merchant associated with the web page wherein the user initiated the “new account” user-triggered event.

In one or more embodiments, the reengagement manager 116 generates the electronic message 310a by personalizing a message template based on the user-triggered event. For example, the reengagement manager 116 personalizes the message template to include text that is a specific to the user of the client-computing device 300. For instance, the text of the electronic message 310a includes personalized text (e.g., “Hi Bryan!”) as well as template text (e.g., “Welcome to solitudecamping.com! Click here to claim your new member gift!”). In at least one embodiment, the reengagement manager 116 generates the personalized text based on the event information (e.g., the user's name, e-mail address, etc.) provided by the client-computing device 300 in response to the initiated user-triggered event and/or based on information stored in a user profile associated with the user.

As illustrated in FIG. 3A, the reengagement manager 116 can also include at least one hyperlink 312a in the electronic message object 306a. In at least one embodiment, the template from which the reengagement manager 116 generates the electronic communication 310a includes the hyperlink 312a. Thus, the merchant can preconfigure the hyperlink 312a to link to a special offer, discount, or so forth. Alternatively, the reengagement manager 116 can select the hyperlink 312a for inclusion in the electronic message object 306a from a list of possible hyperlinks based on event information specific to the initiated user-triggered event. In yet further embodiments, the reengagement manager 116 can request and receive a dynamically generated hyperlink from the merchant for inclusion in the electronic message object 306a.

As mentioned above, the reengagement manager 116 also generates electronic communications in response to other types of user-triggered events. For example, as shown in FIG. 3B, the reengagement manager 116 generates the electronic message object 306b in response to the user of the client-computing device 300 making a purchase via the merchant's website. As illustrated, the electronic message 310b includes personalized text (e.g., “Congrats on your new sleeping bag!”), based on event information provided in response to the user-triggered event.

In one or more embodiments, the reengagement manager 116 can also generate text in response to the user-triggered event. For example, the reengagement manager 116 can include tracking information (e.g., “It should be arriving on Thursday.”), as well as additional upsell offers (e.g., “You might also be interested in this tent.”). In at least one embodiment, the reengagement manager 116 provides this additional text based on the event information provided by the client-computing device 300 (or other client device used by the user to make the purchase). In additional or alternative embodiments, the reengagement manager 116 provides this additional information in response to information received from the merchant server 106.

The reengagement manager 116 can also provide additional interactive elements in the electronic communication object 306b. For example, as shown in FIG. 3B, the reengagement manager 116 can include the hyperlinks 312c and 312d, which link to third-party package tracking and an additional web page hosted by the merchant server 106, respectively. Additionally, as shown in FIG. 3B, the reengagement manager 116 can include media 314. The reengagement manager 116 can include media such as digital images, which may or may not be hyperlinked. Additionally, the reengagement manager 116 can also include video and/or audio files in an electronic communication object, along with a multimedia player application within the electronic message object 306b.

In yet another example, as shown in FIG. 3C, the reengagement manager 116 can generate an electronic message object 306c in response to a user-triggered event initiated when the user of the client-computing device 300 abandons a shopping cart within the merchant's website. As illustrated, the electronic message object 306c includes the electronic message 310c with personalized text (e.g., “We can offer you 10% off the camp stove you left in your shopping cart”), as well as template text (e.g., “Don't leave yet!”). Further, the electronic message object 306c can also include interactive elements, such as the hyperlink 312e, which directs the user to an additional web page or application hosted by the merchant server 106.

In one or more embodiments, because the reengagement manager 116 adds the generated electronic message to a communication thread between the user of the client-computing device 300 and the merchant, the user and the merchant may continue to communicate via the communication thread. For example, in response to receiving the electronic message object 306c, the user of the client-computing device 300 may want to respond to the merchant (e.g., “Solitude Camping”) with a question (e.g., “can I also get free shipping?”). Thus, the user may enter the response, which the reengagement manager 116 will send to the merchant, and add to the communication thread between the user and the merchant. Furthermore, if no communication thread between the user and the merchant has been created previously, the reengagement manager 116 (or social networking system 114 or other electronic messaging system) creates a new communication thread between the user and the merchant.

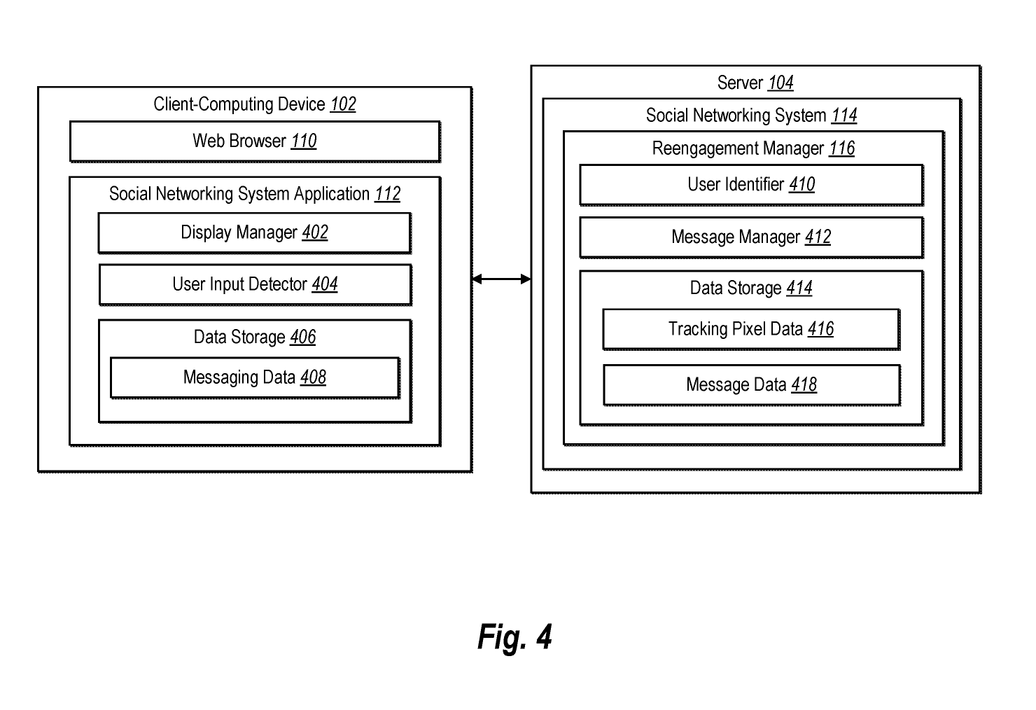

FIG. 4 illustrates a schematic diagram illustrating an example embodiment of the reengagement system 100. As shown in FIG. 4, the reengagement system 100 includes various components for performing the processes and features described herein. For example, as shown in FIG. 4, the reengagement system 100 includes but is not limited to, the client-computing device 102 and the server 104. In one or more embodiments, the client-computing device 102 includes the web browser 110, and the social networking system application 112, which in-turn includes a display manager 402, a user input detector 404, and a data storage 406 storing messaging data 408. Additionally in one or more embodiments, the server 104 hosts the social networking system 114, which in-turn supports the reengagement manager 116. The reengagement manager 116 includes a user identifier 410, a message manager 412, and a data storage 414, which stores tracking pixel data 416 and message data 418.

Each of the components 402-406 of the social networking system application 112, and the components 410-414 of the social networking system 114 can be implemented using a computing device including at least one processor executing instruction that cause the reengagement system 100 to perform the processes described herein. In some embodiments, the components 410-414 can be implemented by the server 104, or across multiple server devices. Additionally or alternatively, a combination of one or more server devices and one or more client devices can implement the components 402-406 of the social networking system application 112. Additionally or alternatively, the components 402-414 can comprise a combination of computer-executable instructions and hardware.

As shown in FIG. 4, the client-computing device 102 includes a web browser 110. As mentioned above, the web browser 110 is a software application that receives and interactively displays web resources (e.g., web pages). Additionally, the web browser 110 also stores or accesses specific files (e.g., a “cookie” or “browser cookie”) used to support various types of website functionality.

In one or more embodiments, the social networking system application 112 is a native application installed on the client-computing device 102. For example, the social networking system application 112 can be a mobile application that installs and runs on a mobile device, such as a smart phone or a tablet computer. Alternatively, the social networking system application 112 can be a desktop application, widget, or other form of a native computer program. Furthermore, the social networking system application 112 may be a remote application accessed by the client-computing device 102. For example, the social networking system application 112 may be a web application that is executed within the web browser 110 of the client-computing device 102.

As mentioned above, and as shown in FIG. 4, the social networking system application 112 includes a display manager 402. The display manager 402 provides, manages, and/or controls a graphical user interface that allows a user to compose, view, and submit social networking system posts and electronic messages. For example, the display manager 402 provides a graphical user interface that facilitates the display of a social networking system user's newsfeed including multiple posts. Similarly, the display manager 402 provides a graphical user interface that displays one or more electronic messages or communication threads received by a social networking system user (e.g., the user of the client-computing device 102).

More specifically, the display manager 402 facilitates the display of a graphical user interface (e.g., by way of a display device associated with the client-computing device 102). For example, the display manager 402 may compose the graphical user interface of a plurality of graphical components, objects, and/or elements that allow a user to compose, send, and receive electronic messages. More particularly, the display manager 402 may direct the client-computing device 102 to display a group of graphical components, objects, and/or elements that enable a user to view electronic messages, communication threads, or social networking system posts.

In addition, the display manager 402 directs the client-computing device 102 to display one or more graphical objects, controls, or elements that facilitate user input for composing, sending, and/or submitting a social networking system post, and/or an electronic message. To illustrate, the display manager 402 provides a graphical user interface that allows a user to provide user input to the social networking system application 112. For example, the display manager 402 provides one or more user interfaces that allow a user to input one or more types of content into a social networking system post or electronic message. As used herein, “content” refers to any data or information to be included as part of a social networking system post or electronic message. For example, the term “content” will be used herein to generally describe text, images, digital media, files, location information, payment information, or any other data that can be included as part of a social networking system post or electronic message.

The display manager 402 can also facilitate the input of text or other data to be included in a social networking system post or electronic message. For example, the display manager 402 provides a user interface that includes a touch display keyboard. A user can interact with the touch display keyboard using one or more touch gestures to input text to be included in a social networking system post or electronic message. For example, a user can use the touch display keyboard to compose a message. In addition to text, the graphical user interface including the touch display keyboard can facilitate the input of various other characters, symbols, icons, or other information.

Furthermore, the display manager 402 is capable of transitioning between two or more graphical user interfaces. For example, in one embodiment, the display manager 402 provides a newsfeed to a social networking system user containing one or more social networking system posts from co-users associated with the user via the social networking system. Later, in response to detected input from the user, the display manager 402 transitions to a second graphical user interface that includes a listing of one or more communication threads between the user and other parties.

As further illustrated in FIG. 4, the social networking system application 112 includes a user input detector 404. In one or more embodiments, the user input detector 404 detects, receives, and/or facilitates user input in any suitable manner. In some examples, the user input detector 404 detects one or more user interactions with respect to the user interface. As referred to herein, a “user interaction” means a single interaction, or combination of interactions, received from a user by way of one or more input devices.

For example, the user input detector 404 detects a user interaction from a keyboard, mouse, touch page, touch screen, and/or any other input device. In the event the client-computing device 102 includes a touch screen, the user input detector 404 detects one or more touch gestures (e.g., swipe gestures, tap gestures, pinch gestures, reverse pinch gestures) from a user that forms a user interaction. In some examples, a user can provide the touch gestures in relation to and/or directed at one or more graphical objects or graphical elements of a user interface.

The user input detector 404 may additionally, or alternatively, receive data representative of a user interaction. For example, the user input detector 404 may receive one or more user configurable parameters from a user, one or more commands from the user, and/or any other suitable user input. The user input detector 404 may receive input data from one or more components of the social networking system 114, or from one or more remote locations.

The social networking system application 112 performs one or more functions in response to the user input detector 404 detecting user input and/or receiving other data. Generally, a user can control, navigate within, and otherwise use the social networking system application 112 by providing one or more user inputs that the user input detector 404 can detect. For example, in response to the user input detector 404 detecting user input, one or more components of the social networking system application 112 allow a user to select a recipient for an electronic message, compose an electronic message, select content to include in an electronic message, and/or send an electronic message to the recipient. Additionally, in response to the user input detector 404 detecting user input, one or more components of the social networking system application 112 allow a user to navigate through one or more user interfaces to review and respond to received electronic messages, etc.

As shown in FIG. 4, and as mentioned above, the social networking system application 112 also includes the data storage 406. The data storage 406 includes messaging data 408. In one or more embodiments, the messaging data 408 is representative of electronic messaging information, such as described herein.

Also as shown in FIG. 4, and as mentioned above, the server 104 hosts the social networking system 114. The social networking system 114 provides social networking system posts and electronic messages (whether text or otherwise) to one or more users of the social networking system 114 (e.g., by way of a profile, a newsfeed, a communication thread, a timeline, or a “wall”). For example, one or more embodiments provide a user with a social networking system newsfeed and electronic messages from one or more co-users associated with the user via the social networking system 114. In one or more embodiments, the user scrolls through the social networking system newsfeed in order to view recent social networking system posts submitted by the one or more co-users associated with the user via the social networking system 114. In one embodiment, the social networking system 114 organizes the social networking system posts chronologically in a user's social networking system newsfeed. In alternative embodiments, the social networking system 114 organizes the social networking system posts geographically, by interest groups, according to a relationship coefficient between the user and the co-user, etc. Additionally, in one or more embodiments, the user can download a copy of the social networking system newsfeed as a record of the social networking system posts displayed thereon.

The social networking system 114 also supports the actions necessary for the user of the client-computing device 102 to exchange electronic messages with other users via the social networking system 114. For example, the social networking system 114 receives an electronic message from a message sender addressed to a message recipient. In response, the social networking system 114 identifies social networking system IDs for both the sender and the recipient and adds the electronic message to a communication thread between the sender and recipient.

For example, the social networking system 114 organizes electronic messages exchanged between the user of the client-computing device 102 and other social networking system users. For example, the social networking system 114 organizes electronic messages chronologically into communication threads. As used herein, a “communication thread” is a group of communications (i.e., electronic messages) sent back and forth between two entities (e.g., a social networking system user of the client-computing device 102 and a merchant). In at least one embodiment, the social networking system 114 also provides a listing of all communication threads in which a user is engaged. By selecting a particular communication thread in the listing, the user can view all messages within the particular communication thread. The social networking system 114 organizes a communication thread such that electronic messages from different parties are formatted and displayed in such a way as to indicate the author of each electronic message. As mentioned above, a communication thread can include electronic messages that consist of text, multimedia, hyperlinks, emoticons, stickers, rich communication objects, etc.

As used herein, a “rich communication object” or “communication object” is a displayed communication that includes structured data. In one or more embodiments, “structured data” can include any data that is structured into specific groups, fields, or categories, and/or is associated with particular aspects of an electronic message. Structured data can include metadata associated with node and edge information related to the electronic message, information related to the electronic message author, information related to a particular item featured in the electronic message, and interaction information related to the electronic message within the social networking system 114. To illustrate, structured data for an electronic message can include formatting information, the electronic message author's name and location, content of the electronic message, or any other specific types of information/data associated with the electronic message. The structured data may also include various multimedia content such as images (e.g., digital pictures, digital map images), video, audio, etc. Using this structured data, the social networking system can facilitate the insertion of “rich” objects within a communication thread or elsewhere, such rich objects providing more information and/or content than typical textual messages.

Thus, in addition to sending, receiving, and organizing electronic messages between social networking system users, the social networking system 114 also provides one or more displays of the communication thread listing, and each individual communication thread to the social networking system application 112 for display on the client-computing device 102. Alternatively, in one or more embodiments, the social networking system application 112 simply accesses the electronic communication information stored by the social networking system 114 and generates displays of the information on the client-computing device 102.

As shown in FIG. 4, the social networking system 114 includes the reengagement manager 116. As an initial matter, the reengagement manager 116 configures and provides tracking pixel computer code, in response to a request from the merchant server 106. As described above, the merchant server 106 can provide tracking pixel parameters (e.g., the type of user-triggered event, the event information necessary to generate an electronic message, etc.) to the reengagement manager 116. In response to receiving the tracking pixel parameters, the reengagement manager 116 generates a portion of computer code that places a pixel on a web page and is triggered by the specified user-triggered event. The merchant can then include the tracking pixel(s) on the merchant's website.

In one or more embodiments, in response to a user-triggered event, the reengagement manager 116 also receives user-triggered event information from the web browser 110 of the client-computing device 102, identifies a social networking system user associated with the user-triggered event information (e.g., the user of the client-computing device 102), and provides an electronic message to the user via the social networking system 114. Additionally, in at least one embodiment, if the user of the client-computing device 102 reengages with the merchant via electronic message, the reengagement manager 116 hosts any resulting communication threads between the user and the merchant.

As shown in FIG. 4, the reengagement manager 116 includes a user identifier 410. As discussed above, in response to a user-triggered event on the client-computing device 102, the web browser 110 provides user-triggered event information to the social networking system 114. From this user-triggered event information, the social networking system 114 can identify the user of the client-computing device 102, access the user's social networking system account, and provide an electronic message to that user via the user's social networking system account.

In one or more embodiments, the user identifier 410 identifies the user of the client-computing device 102 by analyzing the provided user-triggered event information. For example, the user-triggered event information can include the user's name, the user's email address, the user's phone number, the user's social networking system ID, and so forth. With this information, the user identifier 410 seeks to match any of the user's information to information that is stored by the social networking system 114. In at least one embodiment, the user identifier 410 can determine a match has been made between the user-triggered event information and the user information stored by the social networking system 114 when the user identifier 410 matches a threshold amount of user information. For example, the user identifier 410 may positively determine a user's identity when at least two pieces of user information are matched between the provided user-triggered event information and the user information stored by the social networking system 114.

As shown in FIG. 4, and as mentioned above, the reengagement manager 116 also includes a message manager 412. In one or more embodiments, after the user identifier 410 determines an identity of the user of the client-computing device 102, the message manager 412 determines whether to provide an electronic message to the user of the client-computing device 102. In response to determining to send an electronic message, the message manager 412 then generates the electronic message and provides the electronic message to the user.

As mentioned above, the message manager 412 first determines whether an electronic message should be sent to the user of the client-computing device 102 in response to the user-triggered event. In one or more embodiments, the message manager 412 makes this determination by calculating a score based on multiple factors. For example, the message manager 412 can calculate the score based on a relationship coefficient between the user and the merchant as indicated by the user's social networking system usage. To illustrate, the user of the client-computing device 102 may have previously received, and responded to electronic messages from this and other merchants via the social networking system 114. Additionally, the user may have previously submitted posts and/or liked posts from or about the merchant.

Furthermore, the user may have commented on other user's posts that are related to the merchant. Additionally, the user may have social networking system friends who have also engaged with the merchant via posts, likes, comments, electronic messages, etc. In at least one embodiment, the message manager 412 can determine that the user's amount of social networking system activity that is related to the merchant indicates the user would be willing to receive an electronic message from the merchant. Alternatively, the reengagement manager 116 may simply present the user with an option to opt in to receiving electronic messages from the merchant via the social networking system 114.

Additionally, the message manager 412 can calculate the user's score based on other factors. For example, the user may have specifically opted in to receiving electronic messages from this or other merchants. In one or more embodiments, this may be a social networking system profile setting previously configured by the user. Alternatively, the user may have specifically opted in via the merchant. This information can be provided to the reengagement manager 116 along with the other event information in response to the user-triggered event.

In one or more embodiments, the message manager 412 can determine a level of consent based on the calculated score for the user. For example, if the user has a low relationship coefficient with the merchant, the message manager 412 can determine that no more than one electronic message should be sent to the user. If the user has a high relationship coefficient with the merchant, the message manager 412 can determine that multiple electronic messages can be sent to the user, and that the electronic messages can be generated at a higher level of personalization. The calculated score can also indicate when the message manager 412 should send the electronic message (e.g., a low score indicates more time in between the user-triggered event and sending the electronic message, a high score indicates less time in between the user-triggered event and sending the electronic message).

Additionally, as mentioned above, in response to determining that the user of the client-computing device 102 should be provided with an electronic message, the message manager 412 generates the electronic message. In one or more embodiments, in order to generate the electronic message, the message manager 412 first identifies a message template based on the type or category of user-triggered event. In at least one embodiment, the message manager 412 determines the type or category of the user-triggered event by analyzing the user-triggered event information provided by tracking pixel via the web browser 110 of the client-computing device 102. For example, user-triggered event information can include a description of the user action that triggered tracking pixel (e.g., a purchase button click, a web page exit, etc.).

In one or more embodiments, once the message manager 412 determines the type or category of the user-triggered event, the message manager 412 identifies a message template associated with the type or category. For example, in at least one embodiment, the reengagement manager 116 stores message templates that include text and other message elements tailored to different types of user-triggered events. To illustrate, a message template associated with a new account user-triggered event may include the text, “Welcome to your new account! To learn more about your new account please click the link below.” The message template may also include additional elements like a hyperlink, a digital image, a digital video, and so forth.

Next, the message manager 412 can personalized elements in the message template in order to generate the completed electronic message for the user of the client-computing device 102. In one or more embodiments, the personalized elements can include the user's name, information related to the user-triggered event, special offers, and other elements such as hyperlinks and/or digital media. To illustrate, in response to a purchase user-triggered event, the message manager 412 can add information related to the purchase (e.g., “Congrats on your new tent!”), a link to an upsell offer, information on a discount that has been added to the user's account with the merchant, a picture of the item the user just purchased, shipping information, a link to track the shipment, and so forth.

After the message manager 412 generates the electronic message, the message manager 412 provides the electronic message to the user of the client-computing device 102. In one or more embodiments, the message manager 412 provides the electronic message to the user by initiating a new communication thread between the user and the merchant and adding the generated message to the communication thread. In one embodiment, the messaging manager 412 may have previously initiated a communication thread between the user and the merchant. In that case, the messaging manager 412 adds the newly generated electronic message to the previously existing communication thread. Thus, in one or more embodiments, it appears to the user as though the electronic message is coming from the merchant.

In one or more embodiments, in response to being provided with an electronic message, the user of the client-computing device 102 may reengage with the merchant within the initiated communication thread. In that case, the message manager 412 hosts the communication thread between the user and the merchant. In at least one embodiment, the message manager 412 can support a communication thread between the user and the merchant that enables the user and merchant to communication back and forth.

Additionally, as shown in FIG. 4 and as mentioned above, the reengagement manager 116 also includes a data storage 414. As shown, the data storage 414 includes tracking pixel data 416 and message data 418. In one or more embodiments, the pixel data 416 is representative of pixel information, such as described herein. Further, in one or more embodiments, the message data 418 is representative of message information, such as described herein.

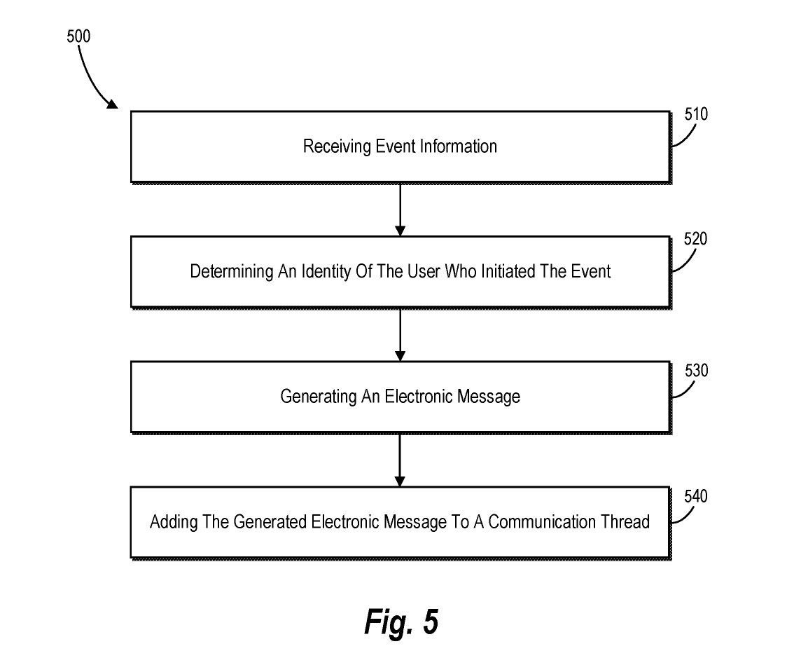

FIGS. 1-4, the corresponding text and examples, provide a number of different methods, systems, and devices for enabling reengagement of a social networking system user with a merchant. In addition to the foregoing, embodiments can also be described in terms of flowcharts comprising acts and steps in a method for accomplishing a particular result. For example, FIG. 5 may be performed with less or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of one example method 500 of reengaging a social networking system user with a merchant. The method 500 includes an act 510 of receiving event information. In particular, the act 510 can involve receiving, in response to a user-triggered event associated with a third-party web page, information related to the user-triggered event. In one or more embodiments, receiving information related to the user-triggered event includes receiving merchant information, user-triggered event information, and user information. In at least one embodiment, receiving information related to the user-triggered event includes one of receiving information related to the user-triggered event from a tracking pixel on a web page or receiving information related to the user-triggered event from a native application.

The method 500 also includes an act 520 of determining an identity of the user who initiated the event. In particular, the act 520 can involve determining, based on the information related to the user-triggered event, an identity of the user associated with the user-triggered event. In one or more embodiments, determining an identity of the user who initiated the user-triggered event includes matching a subset of the information related to the user-trigged event to a social networking system profile.

Additionally, the method 500 includes an act 530 of generating an electronic message based on the event. In particular, the act 530 involves generating, utilizing the information related to the user-triggered event, an electronic message based on the user-triggered event. In one or more embodiments, generating the electronic message based on the user-triggered event includes identifying a message template associated with the user-triggered event, wherein the message template comprises one or more fields, and personalizing the message template based on the received information related to the user-triggered event.

Furthermore, the method 500 includes an act 540 of adding the generated electronic message to a communication thread. In particular, the act 540 involves adding the generated electronic message to a communication thread between the user and a third-party associated with the third-party web page. In one or more embodiments, adding the generated electronic message to the communication thread between the user and the third-party associated with the third-party web page includes initiating the communication thread, indicating the user and the third-party as participants in the communication thread, and adding the generated electronic message to the communication thread. In at least one embodiment, the method 500 further includes, after adding the generated message to the communication thread between the user and the third-party, receiving via the social networking system application a new electronic message from the user for delivery to the third-party, and adding the new electronic message to the communication thread.

In one or more embodiments, the method 500 further includes a step of, prior to generating the electronic message based on the user-triggered event, determining whether to provide an electronic message to the user based on the user-triggered event. For example, determining whether to provide an electronic message to the user based on the user-triggered event can include calculating, based on social networking system information, a relationship coefficient between the user and the third-party associated with the third-party web page. If the relationship coefficient is above a predetermined threshold, determining to provide an electronic message to the user. If the relationship coefficient is below the predetermined threshold, determining not to provide an electronic message to the user.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., posts, photo-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

FIG. 7 illustrates an example network environment 700 of a social networking system. Network environment 700 includes a client device 706, a social networking system 702, and a third-party system 708 connected to each other by a network 704. Although FIG. 7 illustrates a particular arrangement of client device 706, social networking system 702, third-party system 708, and network 704, this disclosure contemplates any suitable arrangement of client device 706, social networking system 702, third-party system 708, and network 704. As an example and not by way of limitation, two or more of client device 706, social networking system 702, and third-party system 708 may be connected to each other directly, bypassing network 704. As another example, two or more of client device 706, social networking system 702, and third-party system 708 may be physically or logically co-located with each other in whole or in part. Moreover, although FIG. 7 illustrates a particular number of client devices 706, social networking systems 702, third-party systems 708, and networks 704, this disclosure contemplates any suitable number of client devices 706, social networking systems 702, third-party systems 708, and networks 704. As an example and not by way of limitation, network environment 700 may include multiple client device 706, social networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client device 706, social networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client device 706 may be an electronic device including hardware, software, or embedded logic components or a combination of two or more such components and capable of carrying out the appropriate functionalities implemented or supported by client device 706. As an example and not by way of limitation, a client device 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 706. A client device 706 may enable a network user at client device 706 to access network 704. A client device 706 may enable its user to communicate with other users at other client devices 706.

In particular embodiments, client device 706 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client device 706 one or more Hyper Text Markup Language (HTML) files responsive to the HTTP request. Client device 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 702 may be a network-addressable computing system that can host an online social network. Social networking system 702 may generate, store, receive, and send social-networking data, such as, for example, user-profile data, concept-profile data, social-graph information, or other suitable data related to the online social network. Social networking system 702 may be accessed by the other components of network environment 700 either directly or via network 704. In particular embodiments, social networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, a social networking system 702, or a third-party system 708 to manage, retrieve, modify, add, or delete, the information stored in data store.

In particular embodiments, social networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 702 may provide users of the online social network the ability to communicate and interact with other users. In particular embodiments, users may join the online social network via social networking system 702 and then add connections (e.g., relationships) to a number of other users of social networking system 702 whom they want to be connected to. Herein, the term “friend” may refer to any other user of social networking system 702 with whom a user has formed a connection, association, or relationship via social networking system 702.

In particular embodiments, social networking system 702 may provide users with the ability to take actions on various types of items or objects, supported by social networking system 702. As an example and not by way of limitation, the items and objects may include groups or social networks to which users of social networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 702 or by an external system of third-party system 708, which is separate from social networking system 702 and coupled to social networking system 702 via a network 704.

In particular embodiments, social networking system 702 may be capable of linking a variety of entities. As an example and not by way of limitation, social networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating social networking system 702. In particular embodiments, however, social networking system 702 and third-party systems 708 may operate in conjunction with each other to provide social-networking services to users of social networking system 702 or third-party systems 708. In this sense, social networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client device 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 702 also includes user-generated content objects, which may enhance a user's interactions with social networking system 702. User-generated content may include anything a user can add, upload, send, or “post” to social networking system 702. As an example and not by way of limitation, a user communicates posts to social networking system 702 from a client device 706. Posts may include data such as status updates or other textual data, location information, photos, videos, links, music or other similar data or media. Content may also be added to social networking system 702 by a third-party through a “communication channel,” such as a newsfeed or stream.

In particular embodiments, social networking system 702 may include a variety of servers, sub-systems, programs, modules, logs, and data stores. In particular embodiments, social networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 702 may also include suitable components such as network interfaces, security mechanisms, load balancers, failover servers, management-and-network-operations consoles, other suitable components, or any suitable combination thereof. In particular embodiments, social networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 702 to one or more client devices 706 or one or more third-party system 708 via network 704. The web server may include a mail server or other messaging functionality for receiving and routing messages between social networking system 702 and one or more client devices 706. An API-request server may allow a third-party system 708 to access information from social networking system 702 by calling one or more APIs. An action logger may be used to receive communications from a web server about a user's actions on or off social networking system 702. In conjunction with the action log, a third-party-content-object log may be maintained of user exposures to third-party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of social networking system 702. A privacy setting of a user determines how particular information associated with a user can be shared. The authorization server may allow users to opt in to or opt out of having their actions logged by social networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client devices 706 associated with users. Advertisement-pricing modules may combine social information, the current time, location information, or other suitable information to provide relevant advertisements, in the form of notifications, to a user.

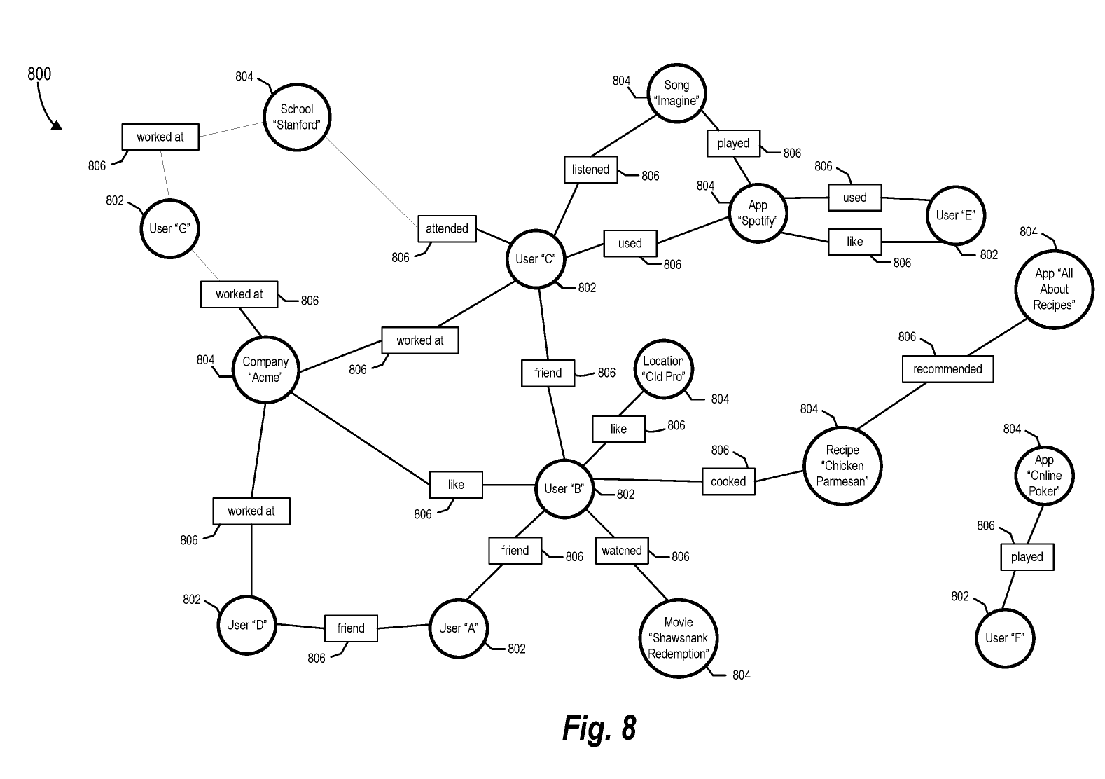

FIG. 8 illustrates example social graph 800. In particular embodiments, social networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social networking system 702, client device 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social networking system 702. As an example and not by way of limitation, a user may be an individual (human user), an entity (e.g., an enterprise, business, or third-party application), or a group (e.g., of individuals or entities) that interacts or communicates with or over social networking system 702. In particular embodiments, when a user registers for an account with social networking system 702, social networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social networking system 702. In particular embodiments, a user node 802 may be associated with information provided by a user or information gathered by various systems, including social networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third-party website associated with a web-application server); an entity (such as, for example, a person, business, group, sports team, or celebrity); a resource (such as, for example, an audio file, video file, digital photo, text file, structured document, or application) which may be located within social networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social networking system 702. Profile pages may also be hosted on third-party websites associated with a third-party server 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 806 to send to social networking system 702 a message indicating the user's action. In response to the message, social networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social networking system 702 may send a “friend request” to the second user. If the second user confirms the “friend request,” social networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social networking system 702 may create an edge 806 between a user node 802 and a concept node 804 in social graph 800. As an example and not by way of limitation, a user viewing a concept-profile page (such as, for example, by using a web browser or a special-purpose application hosted by the user's client device 706) may indicate that he or she likes the concept represented by the concept node 804 by clicking or selecting a “Like” icon, which may cause the user's client device 706 to send to social networking system 702 a message indicating the user's liking of the concept associated with the concept-profile page. In response to the message, social networking system 702 may create an edge 806 between user node 802 associated with the user and concept node 804, as illustrated by “like” edge 806 between the user and concept node 804. In particular embodiments, social networking system 702 may store an edge 806 in one or more data stores. In particular embodiments, an edge 806 may be automatically formed by social networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 702) or RSVP (e.g., through social networking system 702) to an event associated with the advertisement. In addition or as an alternative, an advertisement may include social-networking-system context directed to the user. As an example and not by way of limitation, an advertisement may display information about a friend of the user within social networking system 702 who has taken an action associated with the subject matter of the advertisement.

In particular embodiments, social networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 808 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 702 may calculate a coefficient based on a user's actions. Social networking system 702 may monitor such actions on the online social network, on a third-party system 808, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 702 may calculate a coefficient based on the user's actions with particular types of content. The content may be associated with the online social network, a third-party system 808, or another suitable system. The content may include users, profile pages, posts, news stories, headlines, instant messages, chat room conversations, emails, advertisements, pictures, video, music, other suitable objects, or any combination thereof. Social networking system 702 may analyze a user's actions to determine whether one or more of the actions indicate an affinity for subject matter, content, other users, and so forth. As an example and not by way of limitation, if a user may make frequently posts content related to “coffee” or variants thereof, social networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 702 may calculate a coefficient based on the type of relationship between particular objects. Referencing the social graph 800, social networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 702 may determine that the user has a higher coefficient with respect to the first photo than the second photo because having a tagged-in-type relationship with content may be assigned a higher weight and/or rating than having a like-type relationship with content. In particular embodiments, social networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 806 of the user). A first user may be more interested in other users or concepts that are closer to the first user. As an example and not by way of limitation, if a user is one mile from an airport and two miles from a gas station, social networking system 702 may determine that the user has a higher coefficient for the airport than the gas station based on the proximity of the airport to the user.

In particular embodiments, social networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 702 may provide information that is relevant to user's interests and current circumstances, increasing the likelihood that they will find such information of interest. In particular embodiments, social networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, social networking system 702 may calculate the coefficient (or access the coefficient information if it has previously been calculated and stored). In particular embodiments, social networking system 702 may measure an affinity with respect to a particular process. Different processes (both internal and external to the online social network) may request a coefficient for a particular object or set of objects. Social networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social networking system 702 or shared with other systems (e.g., third-party system 808). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 808, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 702 may send a request to the data store for the object. The request may identify the user associated with the request and may only be sent to the user (or a client device 806 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving, in response to a user-triggered event associated with a third-party web page, information related to the user-triggered event;
determining, by one or more processors and based on the information related to the user-triggered event, an identity of a user associated with the user-triggered event;
generating, by the one or more processors and utilizing the information related to the user-triggered event, an electronic message based on the user-triggered event; and
adding, by the one or more processors, the generated electronic message to a communication thread between the user and a third-party associated with the third-party web page.

2. The method as recited in claim 1, wherein receiving information related to the user-triggered event comprises receiving merchant information, event information, and user information.

3. The method as recited in claim 1, wherein generating the electronic message based on the user-triggered event comprises:
identifying a message template associated with the user-triggered event, wherein the message template comprises one or more fields; and
personalizing the message template based on the received information related to the user-triggered event.

4. The method as recited in claim 3, wherein adding the generated electronic message to the communication thread between the user and the third-party associated with the third-party web page comprises:
initiating the communication thread;
indicating the user and the third-party as participants in the communication thread;
adding the generated electronic message to the communication thread; and
providing the communication thread for display on a user device associated with the user.

5. The method as recited in claim 4, further comprising, after adding the generated electronic message to the communication thread between the user and the third-party, receiving via an application on the user device, a new electronic message from the user for delivery to the third-party, and adding the new electronic message to the communication thread.

6. The method as recited in claim 1, further comprising, prior to generating the electronic message based on the user-triggered event, determining whether to provide an electronic message to the user based on the user-triggered event.

7. The method as recited in claim 6, wherein determining whether to provide an electronic message to the user based on the user-triggered event comprises:
calculating, based on social networking system information, a relationship coefficient between the user and the third-party associated with the third-party web page;
if the relationship coefficient is above a predetermined threshold, determining to provide an electronic message to the user; and
if the relationship coefficient is below the predetermined threshold, determining not to provide an electronic message to the user.

8. The method as recited in claim 1, wherein receiving information related to the user-triggered event comprises receiving the information related to the user-triggered event from a tracking pixel on the third-party web page.

9. A system comprising:
at least one processor; and
at least one non-transitory computer-readable storage medium storing instructions thereon that, when executed by the at least one processor, cause the system to:
receive, in response to a user-triggered event associated with a third-party web page, information related to the user-triggered event;
determine, based on the information related to the user-triggered event, an identity of a user associated with the user-triggered event;
generate, utilizing the information related to the user-triggered event, an electronic message based on the user-triggered event; and
add the generated electronic message to a communication thread between the user and a third-party associated with the third-party web page.

10. The system as recited in claim 9, wherein receiving information related to the user-triggered event comprises receiving merchant information, event information, and user information.

11. The system as recited in claim 10, wherein generating the electronic message comprises:
identifying a message template associated with the user-triggered event, wherein the message template comprises one or more fields; and
personalizing the message template based on the received information related to the user-triggered event.

12. The system as recited in claim 11, wherein adding the generated electronic message to the communication thread between the user and the third-party associated with the third-party web page comprises:
initiating the communication thread;
indicating the user and the third-party as participants in the communication thread;
adding the generated electronic message to the communication thread; and
providing the communication thread for display on a user device associated with the user.

13. The system as recited in claim 12, further comprising instructions that, when executed by the at least one processor, cause the system to, after adding the generated electronic message to the communication thread between the user and the third-party, receive via a social networking or messaging application on the user device, a new electronic message from the user for delivery to the third-party, and adding the new electronic message to the communication thread.

14. The system as recited in claim 13, further comprising instructions that, when executed by the at least one processor, cause the system to, prior to generating the electronic message based on the user-triggered event, determine whether to provide an electronic message to the user based on the user-triggered event.

15. The system as recited in claim 14, wherein determining whether to provide an electronic message to the user based on the user-triggered event comprises:
calculating, based on social networking system information, a relationship coefficient between the user and the third-party associated with the third-party web page;
if the relationship coefficient is above a predetermined threshold, determining to provide an electronic message to the user; and
if the relationship coefficient is below the predetermined threshold, determining not to provide an electronic message to the user.

16. The system as recited in claim 15, wherein receiving information related to the user-triggered event comprises receiving the information related to the user-triggered event from a tracking pixel on the third-party web page.

17. A non-transitory computer-readable medium storing instructions thereon that, when executed by at least one processor, cause a computer system to:
receive, in response to a user-triggered event associated with a third-party web page, information related to the user-triggered event;
determine, based on the information related to the user-triggered event, an identity of a user associated with the user-triggered event;
generate, utilizing the information related to the user-triggered event, an electronic message based on the user-triggered event; and
add the generated electronic message to a communication thread between the user and a third-party associated with the third-party web page.

18. The non-transitory computer-readable medium as recited in claim 17, wherein generating the electronic message based on the user-triggered event comprises:
identifying a message template associated with the user-triggered event, wherein the message template comprises one or more fields; and
creating a rich messaging object using the message template and content received from the third party.

19. The non-transitory computer-readable medium as recited in claim 18, further comprising instructions that, when executed by the at least one processor, cause the computer system to, prior to generating the electronic message based on the user-triggered event, determine whether to provide an electronic message to the user based on the user-triggered event.

20. The non-transitory computer-readable medium as recited in claim 19, wherein determining whether to provide an electronic message to the user based on the user-triggered event comprises:
calculating, based on social networking system information, a relationship coefficient between the user and the third-party associated with the third-party web page;
if the relationship coefficient is above a predetermined threshold, determining to provide an electronic message to the user; and
if the relationship coefficient is below the predetermined threshold, determining not to provide an electronic message to the user.
